(19) United States
(12) Patent Application Publication
(10) Pub. No.: US 2014/0215546 A1
(43) Pub. Date: Jul. 31, 2014

(54) SYSTEMS AND METHODS FOR VIDEO DISTRIBUTION

(71) Applicant: The Boeing Company, (US)

(72) Inventors: Raymond W. Willis, Seattle, WA (US); Thomas L. Buller, Vashon, WA (US); Jeffrey Heim, Renton, WA (US)

(73) Assignee: The Boeing Company, Seal Beach, CA (US)

(21) Appl. No.: 13/752,811

(22) Filed: Jan. 29, 2013

(51) Int. Cl. H04N 21/00

(52) U.S. Cl. CPC H04N 21/00
USPC 725/118

(57) ABSTRACT

Systems and methods for use in distributing video are provided. A first video distribution node includes a video processor configured to receive a video stream from a second video distribution node, and send the video stream to a third video distribution node, such that the video stream is sent substantially near real-time.

### BACKGROUND

The field of the disclosure relates generally to systems and methods for use in video distribution, and more particularly for use in video transmission and replication with metadata.

In the context of unmanned aerial vehicles (UAV), the UAV pilot controls the flight of the vehicle from a tactical operation center (TOC). The pilot or another person controls one or more onboard video cameras. The analog video feed from the vehicle is received at a ground station and must be converted to digital video in order for it to be transmitted over a network. Known systems for promulgating the digital video stream to one or more viewers on an ad-hoc basis may require specialized networks or back-end video servers that receive and distribute the video.

A forward operating base (FOB) may receive video from a variety of video sources. Some video sources are unable to distribute video to more than just the operator. For example, video coming in from a UAV may not be able to be sent to a dismount soldier who is using a smart phone. Accordingly, there is a need for methods and systems for receiving and forwarding video using nodes on a network, including replicating the video only where required to reduce network bandwidth consumption.

### BRIEF DESCRIPTION

In one aspect, a first video distribution node is provided. The first video distribution node includes a video processor configured to receive a video stream from a second video distribution node, and replicate the video stream to a third video distribution node, such that the video stream is sent substantially near real-time.

In another aspect, a first video distribution cloud is provided. The first video distribution cloud includes a video processor configured receive a video stream, and replicate the video stream to a second video distribution node, such that the video stream is sent substantially near real-time.

In yet another aspect, a method for distributing video is provided. The method includes receiving a video stream at near real-time from a source video distribution node within a video distribution network, and re-distributing the video stream at near real-time to at least one video distribution node within the video distribution network.

The features, functions, and advantages that have been discussed can be achieved independently in various implementations or may be combined in yet other implementations further details of which can be seen with reference to the following description and drawings.

### BRIEF DESCRIPTION OF THE DRAWINGS

FIG. 1 is a block diagram of an exemplary computing device.

FIG. 2 is a block diagram of an exemplary video node for use in video distribution.

FIG. 3 is a block diagram of an exemplary cloud for use with the video node of FIG. 2.

FIG. 4 is a block diagram of an exemplary network of clouds for use with the cloud in FIG. 3.

FIG. 5 is a block diagram an exemplary method for distributing video using the video node of FIG. 2.

FIG. 6 is a block diagram of an alternative method for distributing video using the video node of FIG. 2.

FIG. 7 is a block diagram of an exemplary computing device manifested as a smart phone, tablet or laptop hosting the video node from FIG. 2.

### DETAILED DESCRIPTION

The subject matter described herein relates generally to systems and methods for use in video transmission, and more particularly for use in video transmission and replication with metadata. The subject matter includes a system that uses a specific packet format and manages the transmission and replication of digital video and its associated metadata across a distributed system of cooperating nodes, e.g., computers, smart phones, tablets, smart sensors, etc. The system enables the video and metadata to be replicated, or distributed, in near-real-time to as many viewers as desired. The video and/or metadata may be encrypted.

The nodes form a cloud and may use a variety of network communication mechanisms to distribute the video payload to video viewers. Digital video and its associated metadata are multiplexed into a specialized packet format to eliminate time-drift between the video and metadata as the video travels through the cloud. The cloud overcomes typical barriers to moving information across internet protocol (IP) subnets, and it determines which node should replicate, or distribute, a video stream based on the location of the viewers, processor load, and network bandwidth, including in networks that have intermitted connectivity. There is no theoretical limit to the number of viewers that can subscribe to a video stream. A plug-in architecture enables video to be processed, e.g., image analysis for object detection, transcoding for bitrate reduction, etc., at any point or node in the video stream pathway.

In some implementations, technical effects of the methods, systems, and computer-readable media described herein include at least one of: (a) receiving a registration request from a first video distribution node, wherein the registration request includes a video stream identifier, (b) receiving a subscription request from a second video distribution node, wherein the subscription request includes the video stream identifier, and (c) sending a command to the first video distribution node, wherein the command instructs the first video distribution node to send, or replicate or distribute, a video stream associated with the video stream identifier to the second video distribution node.

As used herein, an element or step recited in the singular and preceded with the word “a” or “an” should be understood as not excluding plural elements or steps unless such exclusion is explicitly recited. Furthermore, references to “one implementation” of the present subject matter or the “exemplary implementation” are not intended to be interpreted as excluding the existence of additional implementations that also incorporate the recited features.

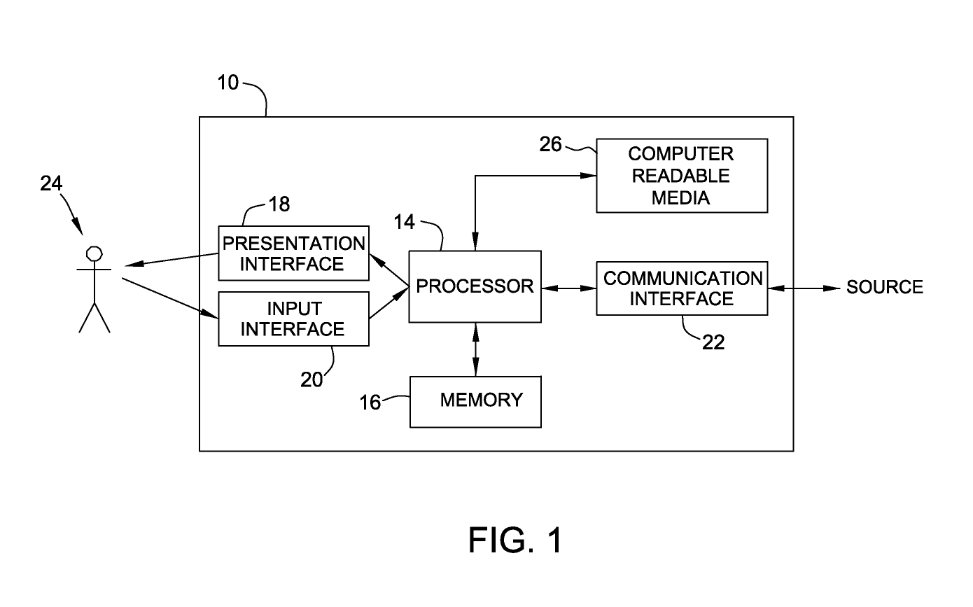

FIG. 1 is a block diagram of an exemplary computing device 10. In the exemplary implementation, computing device 10 includes a memory 16 and a processor 14, e.g., processing device, that is coupled to memory 16, e.g., memory device, for executing programmed instructions. Processor 14 may include one or more processing units (e.g., in a multi-core configuration). Computing device 10 is programmable to perform one or more operations described herein by programming memory 16 and/or processor 14. For example, processor 14 may be programmed by encoding an operation as one or more executable instructions and providing the executable instructions in memory 16.

Processor 14 may include, but is not limited to, a general purpose central processing unit (CPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer-readable medium including, without limitation, a storage device and/or a memory device. Such instructions, when executed by processor 14, cause processor 14 to perform at least a portion of the methods described herein. The above examples are exemplary only, and thus are not intended to limit in any way the definition and/or meaning of the term processor.

Memory 16, as described herein, is one or more devices that enable information such as executable instructions and/or other data to be stored and retrieved. Memory 16 may include one or more computer-readable media, such as, without limitation, dynamic random access memory (DRAM), static random access memory (SRAM), a solid state disk, and/or a hard disk. Memory 16 may be configured to store, without limitation, maintenance event log, diagnostic entries, fault messages, and/or any other type of data suitable for use with the methods and systems described herein.

In the exemplary implementation, computing device 10 includes a presentation interface 18 that is coupled to processor 14. Presentation interface 18 outputs (e.g., display, print, and/or otherwise output) information such as, but not limited to, installation data, configuration data, test data, error messages, and/or any other type of data to an operator 24. For example, presentation interface 18, e.g., output device, may include a display adapter (not shown in FIG. 1) that is coupled to a display device, such as a cathode ray tube (CRT), a liquid crystal display (LCD), a light-emitting diode (LED) display, an organic LED (OLED) display, and/or an “electronic ink” display. In some implementations, presentation interface 18 includes more than one display device. In addition, or in the alternative, presentation interface 18 may include a printer.

In the exemplary implementation, computing device 10 includes an input interface 20, e.g., input device, that receives input from operator 24. In the exemplary implementation, input interface 20 is coupled to processor 14 and may include, for example, a keyboard, a card reader (e.g., a smartcard reader), a pointing device, a mouse, a stylus, a touch sensitive panel (e.g., a touch pad or a touch screen), a gyroscope, an accelerometer, a position detector, and/or an audio input interface. A single component, such as a touch screen, may function as both a display device of presentation interface 18 and as input interface 20.

In the exemplary implementation, computing device 10 includes a communication interface 22 coupled to memory 16 and/or processor 14. Communication interface 22 is provided to receive various types of data and/or information from one or more sources. Communication interface 22 may be a single device or several devices, each dedicated to one or more different type of communications.

Instructions for operating systems and applications are located in a functional form on non-transitory memory 16 for execution by processor 14 to perform one or more of the processes described herein. These instructions in the different implementations may be embodied on different physical or tangible computer-readable media, such as memory 16 or another memory, such as a computer-readable media 26, which may include, without limitation, a flash drive, CD-ROM, thumb drive, floppy disk, etc. Further, instructions are located in a functional form on non-transitory computer-readable media 26, which may include, without limitation, a flash drive, CD-ROM, thumb drive, floppy disk, etc. Computer-readable media 26 is selectively insertable and/or removable from computing device 10 to permit access and/or execution by processor 14. In one example, computer-readable media 26 includes an optical or magnetic disc that is inserted or placed into a CD/DVD drive or other device associated with memory 16 and/or processor 14. In some instances, computer-readable media 26 may not be removable.

Computing device 10 may be implemented in a variety of forms, such as servers, virtual machines, laptops, desktops, etc. Further, in various implementations, computing device 10 may be implemented as one or more portable communication devices or mobile devices, such as a smartphone, a tablet, a portable computer (e.g., an iPad), a personal digital assistant (PDA), etc. Moreover, it should be appreciated that computing devices 10 described herein may include more or fewer components than are illustrated in computing device 10 of FIG. 1.

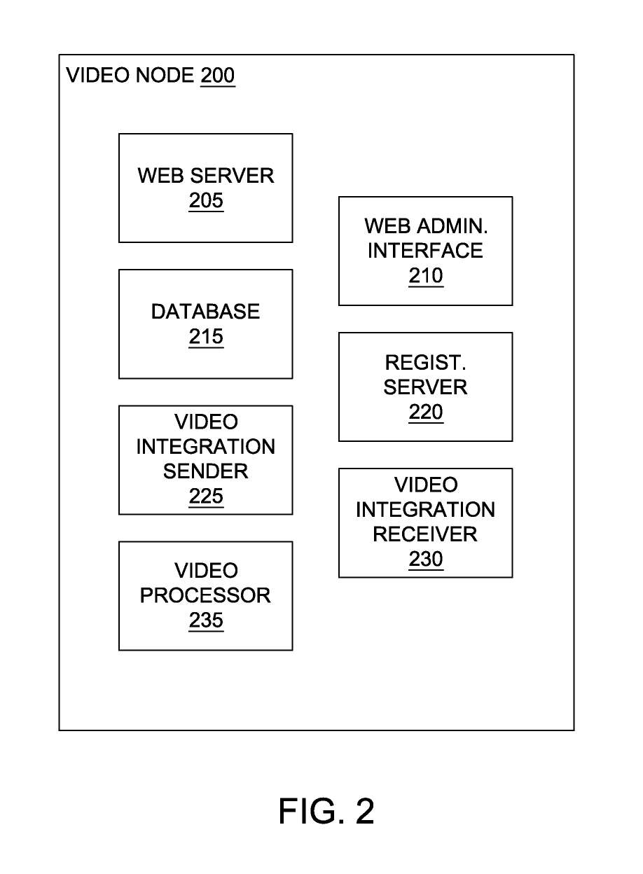

FIG. 2 is a block diagram of an exemplary video node 200 for use in video distribution. Node 200 may be implemented using computing device 10 (shown in FIG. 1). In an exemplary implementation, node 200 may be an instance of a software program running on computing device 10. Computing device 10 may include more than one node 200. In some implementations, video node 200 may be communicatively coupled to a video input device (not shown), such as a camera. The camera may be part of computing device 10 or connected to computing device 10. In some implementations, video node 200 may be communicatively coupled to a video player (not shown), such as a display. The display may be part of computing device 10 or connected to computing device 10. In some implementations, video node 200 may be communicatively coupled to a video input device and a video player, e.g., when computing device 10 is a mobile phone with a camera.

In one implementation, video node 200 may include a web server 205 that may provide a web administrator interface 210. In another implementation, video node 200 may be configured so that a web interface and/or web server 205 is utilized. Web server 205 may be used to provide access to information about node 200. Such information may include, but is not limited to, a current load, e.g. the number of video streams the node is supporting and the names of the streams. Web administrator interface 210 may be used to manually configure node 200 as a producer or consumer of video streams to augment the automatic capabilities of node 200. A database 215 may be used to store information for registration server 200 about available video streams, users, settings, and any data used by video node 200.

In one implementation, video node 200 may include a registration server 220. Registration server 220 may communicate with other nodes 200 or computing devices 10. Registration server 220 may be configured to receive registrations of video streams and provide a list of registered video streams. A database 215 may be used by the registration server node to store information about available video streams, users, settings, and any data used by video node 200. Any node 200 may act as a registration server node, but registration server 220 may typically be disabled on most nodes 200 since only a few registration server nodes may be needed, if at all. In some implementations, video nodes 200 may be capable of discovering video streams without use of a registration server node.

Video node 200 may include a video integration sender 225 and a video integration receiver 230. Sender 225 can be configured to send, or distribute or replicate, digital video packets and associated metadata to a video consumer. Receiver 230 may be configured to receive video packets and metadata from a video producer or video input device. Video node 200 can be configured to send, or distribute or replicate, a video stream emanating from a non-intelligent video producer (i.e. a non-computing device) via receiver 230 or communications interface 22.

A video processor 235 can be configured to combine or separate a video stream and its associated metadata. Video processor 235 can multiplex or demultiplex the video stream and its associated metadata into a particular packet format to eliminate time-drift between the video and metadata as the video stream travels between different nodes 200. Video processor 235 can be further configured using modules and plug-ins. For example, a module can be configured to decode a video stream into individual still images, which may be consumed via a web server, e.g., web server 205. In another example, a plug-in can be configured to decode a proprietary video stream and convert the video stream into a standard H.264 video stream. In yet another example, a plug-in can be configured to convert a high bit-rate video into a low bit-rate video.

In one implementation, video node 200 can be configured to send, or distribute or replicate, a video stream in near real-time such that a node receiving the video stream from the distribution node receives the video stream substantially near a time of capture. While a video stream may be stored by memory 16, distribution of a video stream can occur without storage to prevent and/or eliminate lag of the stream from the producer node.

In one implementation, video node 200 can act as a source of video even if node 200 is not the original producer of the video. Thus, video node 200 can be both a consuming node and a source node of the video stream at the same time. As such, a video node 200 can be configured to receive and source or distribute a video stream nearly simultaneously or substantially at the same time. In one implementation, video node 200 is configured to determine the number of streams node 200 should source to other nodes based on processor load. A source node can otherwise be known as a producer node, a distributor node, or a distributing node. A producer node can be distinguished as an original source of a video stream and associated metadata. A consuming node can otherwise be known as a receiver node or a consumer node.

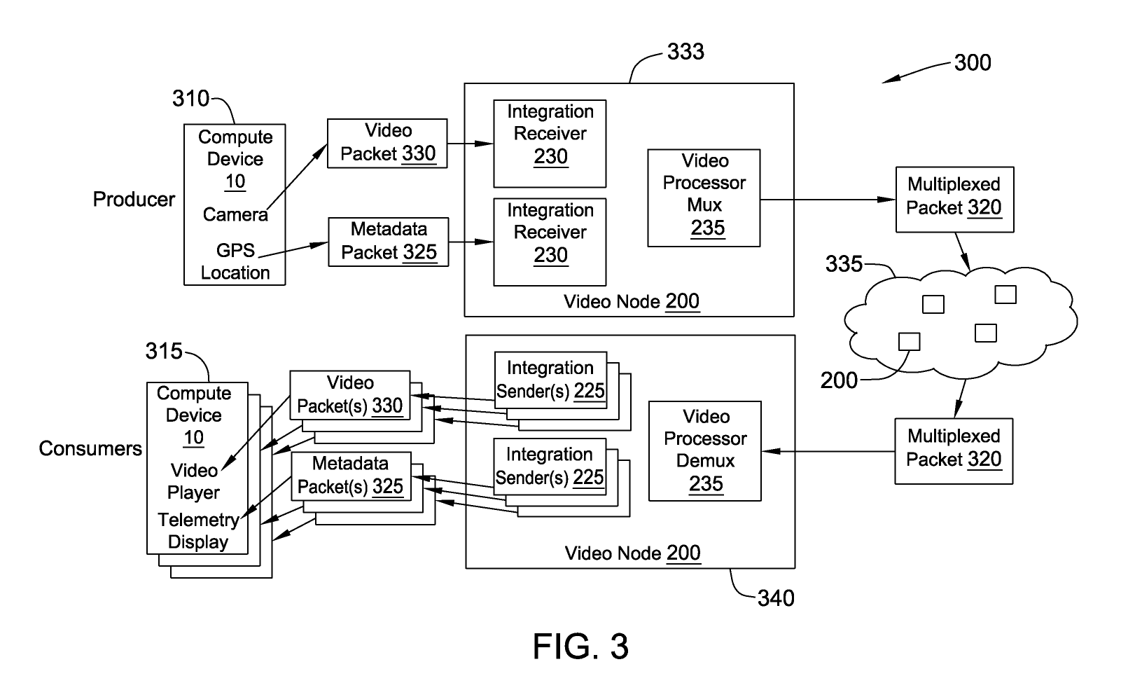

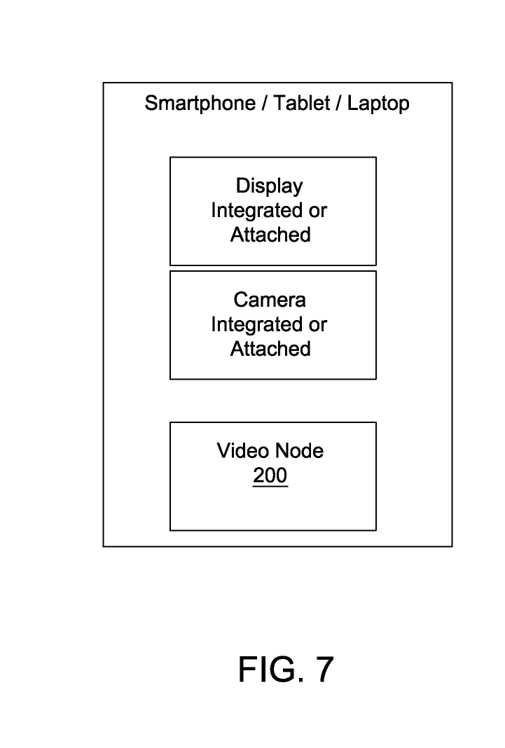

FIG. 3 is a block diagram of an exemplary cloud 300 of video nodes 200 (shown in FIG. 2 and FIG. 7) and computing devices 10 (shown in FIG. 1). Cloud 300 includes two or more nodes 200, which may be part of the same logical network, such as an IP subnet. In one implementation, producers 310 and consumers 315 are computing devices 10 that are not video nodes 200. Producers 310 are cameras or sensors that can emit a video stream and optionally a metadata stream that may contain information about the video stream. Consumers 315 can be a display or other device that can ingest a video stream and optionally a metadata stream. In one implementation of cloud 300, all the nodes 200 are in the same IP subnet. In such an implementation, the individual nodes 200 that make up cloud 300 use discovery to advertise either the video streams they can source, or those that they want to consume. In another implementation, the discovery can include search requests and/or subscription requests that can be broadcast by a requesting consuming node to all other nodes 200. In the instance of a broadcast search request, a user of a consuming node can select a desired video stream from the various results provided back to the requesting consuming node by the other nodes 200. In the instance of a broadcast subscription request, the requesting consuming node can select a video stream source node from the one or more responding potential source nodes in accordance with predetermined criteria, e.g. source node load, communicative proximity, or the like.

A consuming node may send a subscription request based on a name or identifier of a stream. The subscription request can also be based on results of a search that was initiated by the consuming node. The subscription request is sent to all registration server nodes that were discovered or statically configured. The subscription request can also be sent as a broadcast that will be received by any producer video nodes 200.

In another implementation, all nodes 200 make themselves known to a registration server node (not shown) in the cloud (i.e., a node 200 running registration server 220). Nodes 200 may also tell the registration server node which video stream each of nodes 200 can source. When a video consuming node wishes to subscribe to a particular video stream, the consuming node notifies the registration server node of the consuming nodes' interest. The registration server node sends a message to the node 200 that has the video (e.g., the video producer or a node 200 that can source the video). The registration server node then orchestrates the connection between the video producer node or source node and the video consuming node. For video nodes 200 that have a registration server 220, the registration server queries a local database, e.g., database 215, of known producers and/or video sources for those that match the requested video ID. In one implementation, a node can reject and/or ignore a request received from a node that is unknown, unidentifiable, and/or lacking security credentials required by nodes within cloud 300. The registration server node sends to the consuming node a list of matching results.

For broadcast requests, every producer node and/or source node that can respond (i.e., is listening for request broadcasts), queries an internal list of video IDs. A node may respond to the request when the node is the original source of the requested video stream or when the node can receive and distribute the requested video stream from a different node, where the different node can be either another source node or the producer node. The requesting consuming node generates a list of matching results.

For any response, either from producers, source nodes or from registration server nodes, responses are gathered in the consuming node, which employs a best-candidate selection algorithm to select the best source node or producer node. Responses are organized by individual node and video attributes. The best candidate, which may be determined based on logical, physical, or communicative proximity, current load of the node, or video quality, is continually moved to the top of a list. After a pre-determined amount of time, the candidate at the top of the list is selected. The consuming node sends a request for the video stream to the candidate source node at the top of the list. If no candidate is found, the consuming node repeats the entire registration process until the request is satisfied or it is cancelled by some external means, such as by the user, by a timeout, or the like. When a consuming node is receiving a video stream, a monitor process is used to detect a loss of stream. If a stream is lost, the monitor process restarts the acquisition process to locate a new source node for the lost stream.

In one implementation, video and metadata feeds may be managed through a web interface, e.g., web interface 210 (shown in FIG. 2). A web browser may be used to navigate to the web interface. A video stream may be created, named, and associated with a port number. One or more metadata streams may similarly be created, named and associated with a different port numbers and the video stream. An integration receiver 230 is created for each identified stream/port number. The port numbers will be the ports from which the video node 200 will ingest a raw video and metadata from a camera or similar device. The node 200 associated with the web interface may register itself with a registration server node, which may be itself or another node 200. To register, the node provides its node name, the name of the video stream, and any metadata about the stream. For example, metadata may include, but not be limited to only including, the coordinates (e.g. GPS) of the source where the video is being created, movement of the source of video, or any other information about, or associated with, the source of video that facilitates distributing data as described herein. In one implementation, video processor 235 in video node 200 will respond to broadcast requests from consumer video nodes 200 to allow for the pairing of video producers and video consumers if no registration server node is available. If a registration server node becomes available at a later time, the video processor 235 will discover and register with it.

The source node or producer node then listens on the port numbers, e.g., using video receivers 230. Video and metadata provided by the video source are combined, e.g., using video processor 235 (shown in FIG. 2) before transmitting to video consuming nodes.

To subscribe to a video stream, the web interface of the receiving node may be used. A video receiver stream may be created, named, and associated with a port number. One or more metadata streams may similarly be created, named and associated with a different port numbers and the video stream. An integration sender 225 is created for each identified stream/port number. The port numbers will be the ports to which the video node 200 will emit a raw video and metadata to a display or similar device. The receiving node may register itself with a registration server node, which may be itself or another node 200. The receiving node sends a subscription request to the registration server node. To subscribe, the node provides its node name, the name of the video stream it needs, and any metadata about the stream. For example, metadata may include, but not be limited to only including, the coordinates (e.g. GPS) of the source where the video is being created, movement of the source of video, or any other information about the source of video that facilitates distributing data as described herein. The subscribing video node 200 will also broadcast its subscription request. Producer video nodes 200 will respond if nodes 200 can provide, or distribute, the video stream, allowing for the pairing of video producers and video consumers when no registration server node is available. If a registration server node becomes available at a later time, the video processor 235 will discover and register with it.

The registration server node uses the information provided in the subscription request to match the consumer to the producer via a lookup in database 215. If the registration server node finds a match, the registration server node sends a request or command to video processor 235 (shown in FIG. 2), on the requesting consuming node. The consuming node, upon completing a best-candidate selection algorithm, sends a command to the selected source node or producer node to request the video stream.

Similarly, source nodes and/or producer nodes 200 receive broadcast subscription requests from consuming nodes 200. Source nodes or producer nodes use the information provided in the subscription request to determine if they are able to fulfill a request. If a particular source node or producer node determines that it can fulfill a subscription request, it sends a message to the consuming node that issued the broadcast request to inform the consumer that the source node or producer node can supply the video stream. A consuming node, upon completing a best-candidate selection algorithm, sends a command to the selected source node or producer node to request the video stream.

The request, which is sent by consuming node, instructs the producer node or source node to transmit, or distribute, the requested video stream to the receiving node. Video processor 235 on the producer node or source node transmits the requested video stream to video processor 235 on the receiver. The producer node or source node determines if multiple subscription requests are all on the same node and sends, or distributes, only a single video stream to the receiving node. The receiving node may replicate, or distribute, the video for other nodes or consuming nodes. Receiving nodes may subscribe to video streams on producer nodes or source nodes using a registration server node and/or by an automatic discovery process that does not use a registration server node, as described in detail above.

During transmission of a video stream from a producer 310 to one or more consuming nodes 315, video and metadata may be combined into a multiplexed packet 320 by video processor 235. Producer 310 and consuming nodes 315 may include one or more nodes 200. Once packet 320 is created, the packet 320 may be handled as an atomic unit of information, moving through as many nodes 200 as required until the packet 320 reaches node 200 associated with consuming nodes 315 that requested the video. More particularly, video packets 325 from producer 310 and positioning data, or metadata, packets 330 from producer 310 are both transmitted to video processor 235 of a source node 333. Video processor 235 muxes, or combines, the video and positioning data packets 325 and 330 into packet 320. Positioning data packets 330 are provided as an example of metadata, and additional or alternative data may be used as metadata.

Packet 320 may pass through one or more nodes 200 in a network 335. If a registration server node was used, the registration server node may determine and provide a route through network 335 from producer 310 to consumers 315. Packet 320 is delivered to a node 340, which may be the node closest to consumers 315. Node 340, using video processor 235, demuxes, or separates, packet 320 into video and metadata, (e.g. positioning data packets or the like) which are transmitted to consumers 315. Consumers 315 may display video data packets using a video player, and consumer 315 may obtain metadata from the positioning data using a telemetry application. The telemetry application may receive data from a node running on consumer 315 using application programming interfaces or similar methods for passing data to software external to the node.

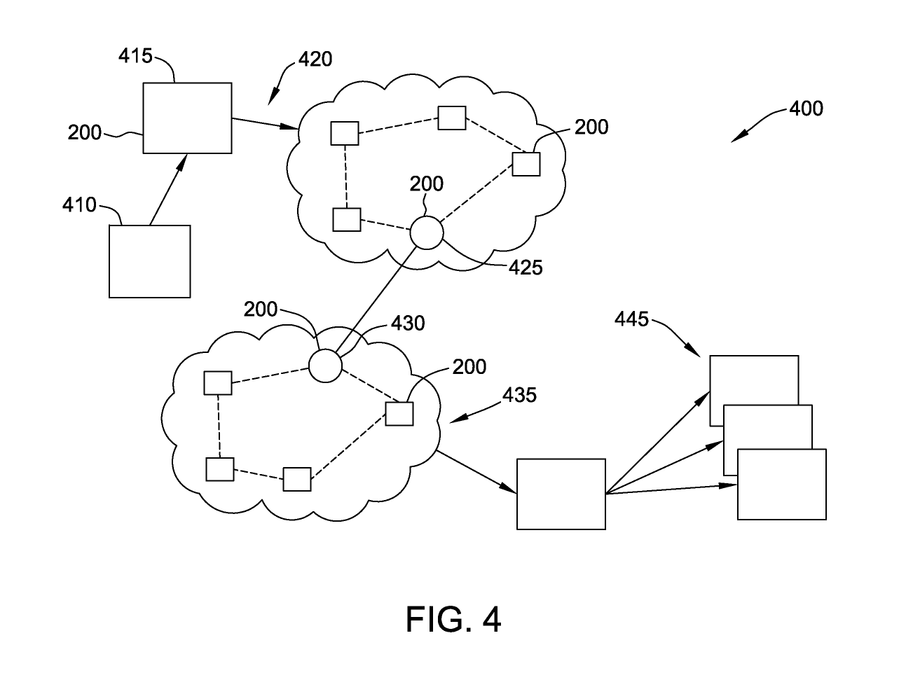

FIG. 4 is a block diagram of an exemplary network 400 of clouds, such as cloud 300 (shown in FIG. 3). Nodes 200 (shown in FIG. 2) may be configured as a collection of nodes such that the nodes 200 form a logical cloud of cooperating computers that can distribute video efficiently amongst each other. For those instances when video must be allowed to leave the local cloud, two or more video nodes 200 can be configured as a bridge node, with at least one in each cloud. In an example of a forward operating base (FOB), there may one satellite uplink available for connecting to a command center. In one implementation, a node can be used as the entry point to the satellite uplink. Any requests for video from the command center can be channeled through this single node. At the command center, on the other end of the satellite link, another node can receive video feeds to replicate and route them as required.

In the exemplary implementation, a video producer 410 sends data to a first node 415, which is part of a first cloud 420. Data is routed through first cloud 420 to a first bridge node 425. First bridge node 425 transmits data to a second bridge node 430 that is associated with a second cloud 435. Thus, bridge nodes 425 and 430 act as gateways for a cloud-to-cloud link 440, which may be bandwidth-constrained. Further, the number of consumers associated with second cloud 435 does not alter the number of streams sent over cloud-to-cloud link 440. Nodes 200 in second cloud 435 replicate the video as needed for one or more consumers 445 associated with second cloud 435.

By way of example and not limitation, a video producer 410 on a first cloud 420 can send, or distribute or uplink, a video stream to a first bridge node 425 that connect to a satellite link. A first user, i.e. consuming node, associated with a second cloud 435, utilizing a mobile device, can connect to bridge node 430, which is is communicatively coupled to bridge node 425 via satellite link, to acquire the video stream from producer 410. More consuming nodes within second cloud 435 can then acquire the video stream from producer 410 as the first user replicates the video for those consumers, such that all users consuming the video stream receive a substantially near real-time version of the video stream.

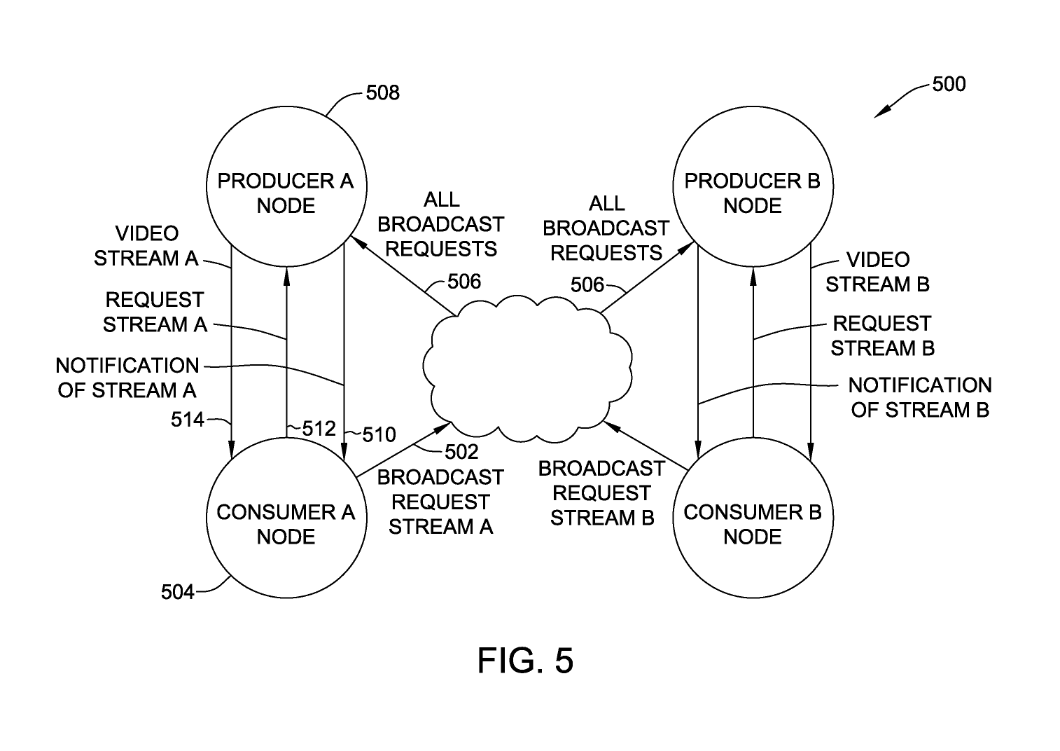

FIG. 5 is a flowchart of an exemplary method 500 for distributing video using producer nodes or video distribution nodes, e.g. node 200 (shown in FIG. 2). In an exemplary implementation, a broadcast request 502 is transmitted by a consuming node 504. In one implementation, broadcast request 502 is transmitted to all producer or distribution nodes. In an exemplary implementation, a producer or distribution node 508 receives broadcast request 502 and transmits a notification message 510 to consuming node 504 that the stream in request 502 is available. In response to message 510, node 504 transmits a subscription request 512 for the stream in message 510. Producer or distribution node 508 then commands, or provides or distributes, the stream in request 512 to consuming node 504. It should be noted that broadcast request 502 and subscription request 512 may include video stream identifiers and/or metadata such as a static address or search criteria of a video stream and/or a video stream producer.

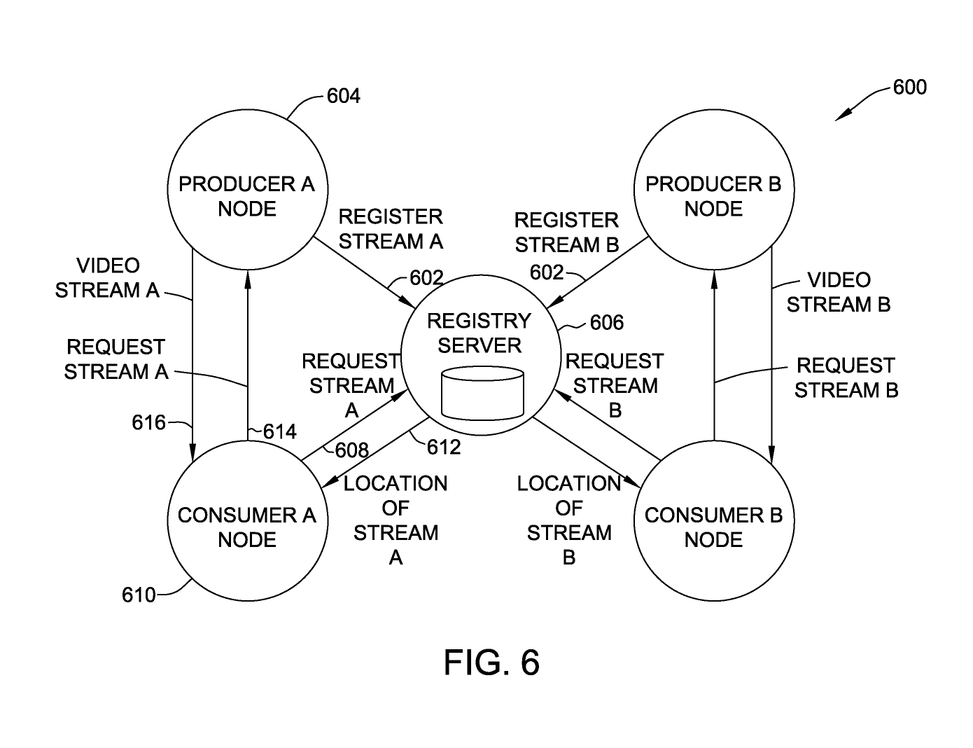

FIG. 6 is a flowchart of an alternative method 600 for distributing video using producer nodes or video distribution nodes, e.g. node 200 (shown in FIG. 2). In an exemplary implementation, registration requests for video streams are transmitted 602 by a producer or distribution node 604. In one implementation, a registry or registration server node 606 registers streams and receives a request 608 for a particular stream, e.g., Stream A. In response to request 608, registry server node 606 transmits a location 612 of the stream in request 608. Node 610 then transmits a subscription request 614 for the stream in request 608. Producer or distribution node 604 commands, or provides or distributes, the stream in request 614 to consuming node 610. It should be noted that request 608 and subscription request 614 may include video stream identifiers and/or metadata such as a static address or search criteria of a video stream and/or a video stream producer.

In some implementations, registration server node 606 determines a route for the video stream to take from a first video distribution node to the consuming node. The route may include one or more nodes that communicatively couple a first video distribution node and a second video distribution node. The command may also include the route. As described herein, the registration request, broadcast request, subscription request, and/or command may be but are not necessarily sent as web requests. The registration request, broadcast request, subscription request, and/or command may include other data, such as a node identifier, port number, and/or metadata about the video stream. In some implementations, method 600 includes responding to registration server node location messages, which are messages sent as a broadcast to a network to identify registration server nodes in an attempt to automatically discover registration server nodes. If the broadcast message is received, a response may include information about the registration server node, such as a network address, and may be sent by the registration server node or another node.

The implementations described herein provide a novel system and methods for distributing video substantially near real-time. The use of nodes enables the systems and methods described herein to send, or distribute or replicate, video streams from a source or producer in a replication or repeating manner, and in a serial and parallel manner to one or more nodes. Such distribution occurs without the storage of video streams such that lag between the capture of video by a producer and display to a consumer is substantially prevented and/or eliminated. Such distribution also enables nodes to act as sources of video streams eliminating the need for a centralized distribution center in known systems.

It should be appreciated that one or more aspects of the present disclosure transform a general-purpose computing device into a special-purpose computing device when configured to perform the functions, methods, and/or processes described herein.

This written description uses examples to disclose various implementations, which include the best mode, to enable any person skilled in the art to practice those implementations, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A first video distribution node comprising:
a video processor configured to:
receive a video stream from a second video distribution node; and
send the video stream to a third video distribution node, such that the video stream is sent substantially near real-time.

2. A first video distribution node in accordance with claim 1, wherein the video processor is further configured to receive and send the video stream substantially simultaneously.

3. A first video distribution node in accordance with claim 1, further comprising a registration server configured to receive at least one video stream registration and at least one video stream request, wherein said registration server is further configured to associate a first video stream request with a first video stream registration.

4. A first video distribution node in accordance with claim 1, wherein said video processor broadcasts a video distribution request to at least the second video distribution node.

5. A first video distribution node in accordance with claim 1, wherein said video processor is further configured to receive a video stream from at least one of another video distribution node or a video source capturing the video stream.

6. A first video distribution node in accordance with claim 5, wherein the third video distribution node is communicatively coupled to said first video distribution node via at least a fourth video distribution node.

7. A first video distribution node in accordance with claim 1, wherein said video processor is further configured to combine metadata about the video stream with the video stream and separate metadata about the video stream from the video stream.

8. A first video distribution node in accordance with claim 1, wherein said first video distribution node is configured to re-distribute the video stream.

9. A first video distribution node in accordance with claim 1, wherein said first video distribution node is a software application running on a computing device.

10. A first video distribution node in accordance with claim 9, wherein said computing device is a mobile device.

11. A first video distribution cloud comprising a plurality of video distribution nodes, each video distribution node comprising:
a video processor configured to:
receive a video stream; and
send the video stream to a second video distribution node, such that the video stream is sent substantially near real-time.

12. A first video distribution cloud in accordance with claim 11, wherein said video processor broadcasts a video distribution request to at least the second video distribution node.

13. A first video distribution cloud in accordance with claim 11, wherein the video processor is further configured to receive and send the video stream substantially simultaneously.

14. A first video distribution cloud in accordance with claim 11, wherein said plurality of video distribution nodes includes a registration server node that comprises a registration server configured to receive at least one video stream registration and at least one video stream request, wherein the registration server is further configured to associate a first video stream request with a first video stream registration.

15. A first video distribution cloud in accordance with claim 11, wherein said plurality of video distribution nodes includes a first bridge node communicatively coupled to a second bridge node in a second video distribution cloud.

16. A first video distribution cloud in accordance with claim 15, wherein the processor is further configured to send the video stream to a second video distribution node in the second video distribution cloud via said first bridge node.

17. A method for distributing video, said method comprising:
receiving a video stream at near real-time from a source video distribution node within a video distribution network; and
re-distributing the video stream at near real-time to at least one video distribution node within the video distribution network.

18. A method for distributing video in accordance with claim 17, wherein the receiving the video stream further comprises:
sending a first video stream request from a first video distribution node, wherein the first video stream request includes a video stream identifier;
sending a first subscription request from the first video distribution node to a second video distribution node, wherein the first subscription request includes the video stream identifier; and
sending a command to the second video distribution node, wherein the command instructs the second video distribution node to send a video stream associated with the video stream identifier to the first video distribution node.

19. A method for distributing video in accordance with claim 18, wherein the re-distributing the video stream further comprises:
receiving a second video stream request by the first video distribution node from at least a third video distribution node, wherein the second video stream request includes the video stream identifier;
receiving a second subscription request by the first video distribution node from at least a third video distribution node, wherein the second subscription request includes the video stream identifier; and
distributing, by the first video distribution node, the video stream associated with the video stream identifier to at least the third video distribution node.

20. A method in accordance with claim 18, further comprising determining a route for the second video distribution node to use in sending the video stream to the first video distribution node.

21. A method in accordance with claim 17, wherein re-distributing the video stream occurs substantially at the same time as receiving the video stream.
